(19) United States
(12) Patent Application Publication
(10) Pub. No.: US 2018/0246606 A1
(43) Pub. Date: Aug. 30, 2018

(54) Touch Screen Panel and Manufacturing Method Thereof, and Display Device

(71) Applicants: BOE Technology Group Co., Ltd., Beijing (CN); Hefei Xinsheng Optoelectronics Technology Co., Ltd., Hefei (CN)

(72) Inventors: Ting Zeng, Bejing (CN); Taofeng Xie, Beijing (CN); Biao Du, Beijing (CN); Kefeng Li, Beijing (CN); Liang Yan, Beijing (CN); Haifeng Hu, Beijing (CN)

(73) Assignees: BOE Technology Group Co., Ltd., Beijing (CN); Hefei Xinsheng Optoelectronics Technology Co., Ltd., Hefei (CN)

(21) Appl. No.: 15/561,792

(22) PCT Filed: May 19, 2017
(86) PCT No.: PCT/CN2017/085127

§ 371 Date: Sep. 26, 2017

(30) Foreign Application Priority Data
Jun. 29, 2016 (CN) 201610499991.1

(51) Int. Cl. G06F 3/041; G06F 1/16

(52) U.S. Cl. CPC G06F 3/0412; G06F 2203/04103; G02F 2201/12; G06F 1/1643

(57) ABSTRACT

A touch screen panel and a manufacturing method thereof and a display device are provided. The manufacturing method for a touch screen includes: forming an auxiliary film layer on a first substrate, wherein the auxiliary film layer includes a catalyst capable of accelerating a formation reaction rate of graphene; patterning the auxiliary film layer to obtain an auxiliary pattern layer having a first pattern; forming a graphene pattern layer on the auxiliary pattern layer, the graphene pattern layer having a second pattern; forming a base film on the graphene pattern layer; and removing the first substrate and the auxiliary pattern layer.

### TECHNICAL FIELD

Embodiments of the present disclosure relate to a touch screen panel and a manufacturing method thereof, and a display device.

### BACKGROUND

With rapid development of a display technology, touch screen panels have been gradually popularized in people's life. At present, according to working principle, the touch screen panels can be divided into a resistance type, a capacitive type, an infrared type, as well as a surface sound wave type, an electromagnetic type, a vibration sensing type, an inhibited total internal reflection optical sensing type, etc., wherein the capacitive touch screen panels become a new favorite in the industry due to advantages of high sensitivity, long service life, high transmittance, and the like.

A One Glass Solution (OGS) touch screen panel is a technology which directly forms a capacitive touch control sensor on protective glass, one piece of glass plays double roles of protecting glass and touch control sensor simultaneously, and a main disadvantage of the OGS technology lies in that a glass substrate is insufficient in hardness, and its screen is easy to break when falling. A One Plastic Solution (OPS) technology can solve this problem, the OPS mainly prepares the touch control sensor on a transparent plastic substrate and finally connects the touch control sensor to a display module to form a plastic cover lens, the OPS has a technical advantage of saving cost and can be implemented in wearable touch control, but current difficulties are that the plastic substrate is not resistant to a high temperature and operation is not easy during manufacturing since the plastic substrate is relatively soft.

### SUMMARY

An embodiment of the present disclosure provides a manufacturing method for a touch screen, including: forming an auxiliary film layer on a first substrate, wherein the auxiliary film layer includes a catalyst capable of accelerating a formation reaction rate of graphene; patterning the auxiliary film layer to obtain an auxiliary pattern layer having a first pattern; forming a graphene pattern layer on the auxiliary pattern layer, the graphene pattern layer having a second pattern; forming a base film on the graphene pattern layer; and removing the first substrate and the auxiliary pattern layer.

In an example, the second pattern is substantially consistent with the first pattern.

In an example, the graphene pattern layer is configured as a touch electrode layer.

In an example, the forming a graphene pattern layer on the auxiliary pattern layer includes: growing the graphene pattern layer on the auxiliary pattern layer within a temperature range of 900-1100° C. by adopting a chemical vapor deposition method.

In an example, the base film is a flexible plastic base film, and the forming a base film on the graphene pattern layer includes: dissolving powdery plastic in an organic solvent to form a solution; coating the solution on the graphene pattern layer; and baking the solution to form the base film.

In an example, the removing the first substrate and the auxiliary pattern layer includes: soaking at least the auxiliary pattern layer in a ferric chloride solution, such that the first substrate and the auxiliary pattern layer are separated from the graphene pattern layer.

In an example, a material of the auxiliary film layer includes metal or metallic compounds.

In an example, a material of the auxiliary film layer includes one or more selected from a group consisting of: gold, silver, copper, zinc, iron, cobalt and nickel.

In an example, the auxiliary film layer is a copper film or a nickel film, and a thickness of the auxiliary film layer is 300 nm to 500 nm.

In an example, the first substrate is a quartz substrate or an aluminum oxide substrate.

In an example, the flexible base film includes polyacrylic plastic.

In an example, the manufacturing method further includes: after removing the first substrate and the auxiliary pattern layer, transferring the base film and the graphene pattern layer thereon to a flexible substrate.

Another embodiment of the present disclosure provides a touch screen panel manufactured by adopting the manufacturing method described above, comprising a graphene pattern layer, configured as a touch control electrode layer.

Yet another embodiment of the present disclosure provides display device, comprising the touch screen panel described above.

### BRIEF DESCRIPTION OF THE DRAWINGS

In order to clearly illustrate the technical solution of the embodiments of the disclosure, the drawings of the embodiments will be briefly described in the following; it is obvious that the described drawings are only related to some embodiments of the disclosure and thus are not limitative of the disclosure.

FIG. 1 is a flowchart of a manufacturing method for a touch screen panel provided by an embodiment of the present disclosure; and

FIG. 2 is a schematic diagram of a manufacturing process for a touch screen panel provided by an embodiment of the present disclosure.

### DETAILED DESCRIPTION

In order to clarify the objects, technical solutions and advantages of the present disclosure, the technical solutions of embodiments of the present disclosure will be described in a clearly and fully understandable way in connection with the drawings of the embodiments of the present disclosure. It is obvious that the described embodiments are just a part but not all of the embodiments of the disclosure. Based on the described embodiments of the present disclosure herein, those ordinary skilled in the art can obtain all other embodiment(s), without any inventive work, which should be within the scope of the disclosure.

### Embodiments

Graphene is a two dimensional crystal formed by carbon atoms and only having a thickness of one layer of atoms. The graphene material can be made very thin, meanwhile, the graphene material is also a very tenacious material, and has a breaking strength which is 200 times higher than that of a steel material. Meanwhile, the graphene material has very good elasticity, and has a stretching amplitude which can reach 20% of a size thereof. The current most potential application of the graphene is to become a substitute good for silicon, and is manufactured into a superminiature transistor and used for producing a super computer in the future. If the graphene replaces the silicon, an operating speed of a computer processor will be accelerated by hundreds of times. In addition, the graphene is almost transparent completely, and only absorbs 2.3% of light. In another aspect, it is very compact, and even the minimal gas atoms (helium atoms) cannot penetrate therethrough. Due to these characteristics, it is very suitable for serving as a raw material for transparent electronic products, such as transparent touch display screens, light emitting boards and solar cell panels.

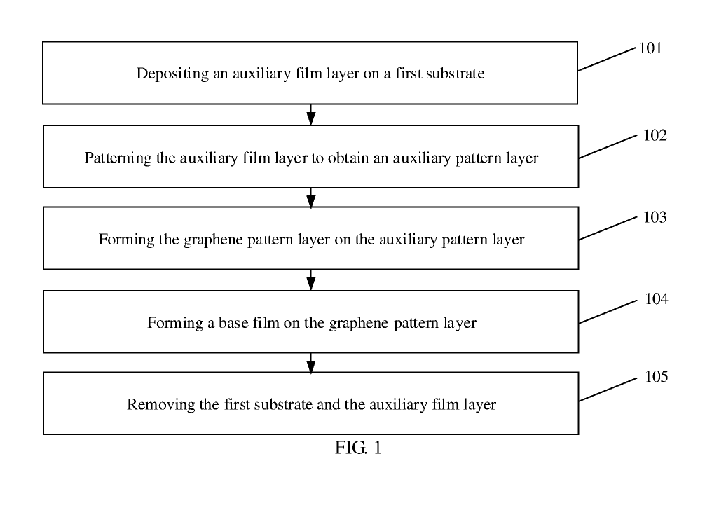

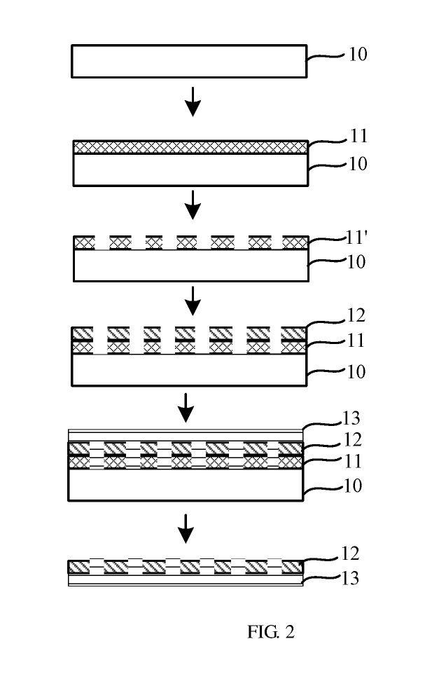

The embodiments of the present disclosure relate to application of the graphene material to touch control products. For example, an embodiment of the present disclosure provides a manufacturing method for a touch screen panel, which, as shown in FIGS. 1 and 2, includes:

101: depositing an auxiliary film layer 11 on a first substrate 10;

Herein, the auxiliary film layer 11 includes a catalyst capable of accelerating a formation reaction rate of graphene. The first substrate 10 selects a high temperature-resistant and easy-to-operate hard substrate such as a quartz substrate or an aluminum oxide substrate, etc. The catalyst required for preparing the graphene can be metals or metallic compounds such as one or more of gold, silver, copper, zinc, iron, cobalt and nickel, but shouldn't be limited to the above as long as that growth of the graphene can be promoted, and an auxiliary pattern layer 11′ in step 103 can be used to grow a required graphene pattern layer 12.

For example, in this step, depositing a layer of auxiliary film layer 11 on the first substrate 10 can include: depositing a Cu film or Ni film of 300 nm to 500 nm, as the auxiliary film layer 11, on the quartz substrate or aluminum oxide substrate.

102: patterning the auxiliary film layer 11 to obtain an auxiliary pattern layer;

For example, by a patterning process, the auxiliary film layer 11 is patterned to obtain the auxiliary pattern layer. The patterning process includes a step of patterning the film layer and for example, can be a general photoetching process, which is also called as photolithography process and can include steps of cleaning and baking, priming, photoresist spin coating, soft baking, aligning and exposure, postbaking, developing, hard baking, etching, detecting, and the like. In this step, the auxiliary film layer 11 is patterned. For example, a pattern of the photoresist (similar to a touch control electrode pattern of the OGS of a monolayered structure) is formed by exposure and developing, and then corresponding etchant is adopted to obtain a corresponding touch control pattern of the auxiliary pattern layer 11′. Herein, the manufactured touch control pattern of the auxiliary film layer is consistent with the pattern of a touch control electrode layer capable of realizing a touch control function.

103: forming the graphene pattern layer 12 on the auxiliary pattern layer 11′;

In this step, the graphene pattern layer 12 is prepared on the patterned auxiliary pattern layer 11′. Because the auxiliary pattern layer 11′ includes the catalyst required for forming the graphene, under inductive and catalytic actions of the catalyst, the graphene is formed into a film only in a place where the catalyst presents; and finally, the patterned graphene pattern layer 12 is directly formed on the auxiliary pattern layer 11′, that is, the graphene pattern layer 12 has a touch control pattern essentially consistent with the auxiliary pattern layer 11′.

Exemplarily, this step can be executed in such manner adopting a CVD method to directly grow the graphene pattern layer 12 on the auxiliary pattern layer 11′ formed by the Cu film or Ni film within a temperature range of 900 to 1100° C.

104: forming a base film 13 on the graphene pattern layer 12;

In this step, for example, a layer of base film 13 is covered on the graphene pattern layer 12, and an implementing manner is not limited. The flexible base film 13 can be a flexible plastic base film, for example, polyacrylic plastic. In this step, the flexible base film 13 is formed as a base substrate of the graphene pattern layer 12, so that subsequent steps of transferring the graphene pattern layer can be executed, and touch control flexibility is also realized. Exemplarily, the flexible base film in this step can be a plastic base film, correspondingly, the step can be executed in such a manner dissolving powdery plastic in an organic solvent to form a solution, and coating the solution on the graphene pattern layer 12 obtained in the above step 103; and then baking to form the flexible base film 13. For example, process conditions can be that acidic plastic (PMMA) powder is dissolved in the organic solvent to form the solution, and the solution is then coated on the first substrate 10 with the graphene touch control pattern formed thereon, and a coating thickness is 0.4 mm to 0.7 mm.

105: removing the first substrate 10 and the auxiliary film layer 11.

In this step, the first substrate 10 and the auxiliary film layer 11 are removed, and an implementing manner is not limited. For example, the first substrate 10 subjected to the steps 101 to 104 can be soaked in a ferric chloride solution, such that the first substrate 10 and the auxiliary film layer 11 are stripped off from the graphene pattern layer 12, soaking time depends on the auxiliary film layer 11 and a concentration of the ferric chloride solution, for example, soaking is performed for more than a dozen of hours, taking that the auxiliary film layer 11 can be etched away to remove the first substrate 10 as a criterion. By soaked in the ferric chloride solution, a cover lens covered by the flexible base film 13 (for example, polymethyl methacrylate) and patterned graphene can be obtained.

In the steps 104 and 105, the graphene pattern layer is transferred to the transparent flexible base film 13 from the first substrate 10 for realizing flexibility and solving a problem of difficulty in operation when a plastic substrate is manufactured. The transferring process is not limited to the manner above, and for example, can be realized in the following manner.

In the step 104, curing is performed after a thinner solution is coated (i.e., a thinner flexible base film 13 is formed), then similarly, soaked in the ferric chloride solution is performed for a dozen of hours to etch away the auxiliary film layer 11, and the flexible base film covered by the patterned graphene is taken out to be transferred to the flexible substrate prepared in advance.

In the embodiment of the present disclosure, the graphene material is adopted to prepare the touch control electrode, a technological process thereof is optimized to realize OPS; by preparing a monolayered graphene touch control pattern, and transferring the graphene touch control pattern to the flexible base film (for example, transparent plastic) from the first substrate 10 to realize touch control and cover lens protection, the problem of high cost of current OGS toughened glass can be solved, and meanwhile, a very good solution is provided in the fields of wearable touch control and flexible touch control.

An embodiment of the present disclosure further provides a touch screen panel manufactured by adopting the above manufacturing method of claims, and the touch screen panel includes the graphene pattern layer 12 having the touch control pattern. The touch screen panel can realize flexible display, and because the graphene material is used, a higher transmittance can be obtained.

An embodiment of the present discourse further provides a display device, comprising the above touch screen panel. The display device can realize flexible display, and because the graphene material is used, a higher display quality can be obtained. The display device can be any products or parts having a display function, such as liquid crystal panels, electronic paper, OLED panels, cellphones, tablet computers, televisions, displays, laptops, digital photo frames, navigators, etc.

In the embodiments of the present disclosure, the serial numbers of the respective steps are not intended to limit a sequence of the respective steps, and for those ordinary skilled in the art, changes to the sequence of the respective steps, without any inventive work, should be within the scope of the embodiments of the present disclosure.

The foregoing embodiments merely are exemplary embodiments of the disclosure, and not intended to define the scope of the disclosure, and the scope of the disclosure is determined by the appended claims.

The application claims priority of Chinese Patent Application No. 201610499991.1 filed on Jun. 29, 2016, the disclosure of which is incorporated herein by reference in its entirety as part of the present application.

1. A manufacturing method for a touch screen, comprising:
forming an auxiliary film layer on a first substrate, wherein the auxiliary film layer includes a catalyst capable of accelerating a formation reaction rate of graphene;
patterning the auxiliary film layer to obtain an auxiliary pattern layer having a first pattern;
forming a graphene pattern layer on the auxiliary pattern layer, the graphene pattern layer having a second pattern;
forming a base film on the graphene pattern layer; and
removing the first substrate and the auxiliary pattern layer.

2. The manufacturing method according to claim 1, wherein the second pattern is substantially consistent with the first pattern.

3. The manufacturing method according to claim 1, wherein the graphene pattern layer is configured as a touch electrode layer.

4. The manufacturing method according to claim 1, wherein the forming a graphene pattern layer on the auxiliary pattern layer includes:
growing the graphene pattern layer on the auxiliary pattern layer within a temperature range of 900-1100° C. by adopting a chemical vapor deposition method.

5. The manufacturing method according to claim 1, wherein the base film is a flexible plastic base film, and the forming a base film on the graphene pattern layer includes:
dissolving powdery plastic in an organic solvent to form a solution;
coating the solution on the graphene pattern layer; and
baking the solution to form the base film.

6. The manufacturing method according to claim 1, wherein the removing the first substrate and the auxiliary pattern layer includes:
soaking at least the auxiliary pattern layer in a ferric chloride solution, such that the first substrate and the auxiliary pattern layer are separated from the graphene pattern layer.

7. The manufacturing method according to claim 1, wherein a material of the auxiliary film layer includes metal or metallic compounds.

8. The manufacturing method according to claim 1, wherein a material of the auxiliary film layer includes one or more selected from a group consisting of: gold, silver, copper, zinc, iron, cobalt and nickel.

9. The manufacturing method according to claim 1, wherein the auxiliary film layer is a copper film or a nickel film, and a thickness of the auxiliary film layer is 300 nm to 500 nm.

10. The manufacturing method according to claim 1, wherein the first substrate is a quartz substrate or an aluminum oxide substrate.

11. The manufacturing method according to claim 1, wherein the flexible base film includes polyacrylic plastic.

12. The manufacturing method according to claim 1, further comprising:
after removing the first substrate and the auxiliary pattern layer, transferring the base film and the graphene pattern layer thereon to a flexible substrate.

13. A touch screen panel manufactured by adopting the manufacturing method according to claim 1, comprising a graphene pattern layer, configured as a touch control electrode layer.

14. A display device, comprising the touch screen panel according to claim 13.
